(19) United States
(12) Patent Application Publication
(10) Pub. No.: US 2019/0111964 A1
(43) Pub. Date: Apr. 18, 2019

(54) FAIL-SAFE CONTROL APPARATUS AND CONTROL METHOD FOR ELECTRIC POWER STEERING SYSTEM, AND STEERING SYSTEM

(71) Applicant: MANDO CORPORATION, Pyeongtaek-si (KR)

(72) Inventor: Tae Woo KIM, Seongnam-si (KR)

(73) Assignees: MANDO CORPORATION, Pyeongtaek-si, Gyeonggi-do (KR); MANDO CORPORATION, Pyeongtaek-si, Gyeonggi-do (KR)

(21) Appl. No.: 16/160,569

(22) Filed: Oct. 15, 2018

(30) Foreign Application Priority Data
Oct. 16, 2017 (KR) 10-2017-0133959

(51) Int. Cl. B62D 5/04; B62D 15/02

(52) U.S. Cl. CPC B62D 5/049; B62D 15/0215; B62D 5/0463; B62D 5/0484

(57) ABSTRACT

Exemplary embodiments relate to a fail-safe control and a control method for an electric power steering system and a steering system. The fail-safe control apparatus of the electric power steering system may include a first sensing unit configured to sense motor position information, which is rotor position information of a motor that supplies an auxiliary steering force for a vehicle, and motor direction information, which is rotation direction information of the motor, a second sensing unit configured to sense steering torque information or steering angle information of the vehicle, a failure determination unit configured to compute a difference for the motor position information, estimate a direction value of the motor direction information, and perform computation between the motor position information and the steering torque information or the steering angle information to determine whether a failure has occurred, and a steering control unit configured to reduce or block an electric current output of the motor according to a result of the determination.

### CROSS REFERENCE TO RELATED APPLICATION

This application claims priority from Korean Patent Application No. 10-2017-0133959, filed on Oct. 16, 2017, which is hereby incorporated by reference for all purposes as if fully set forth herein.

### BACKGROUND OF THE INVENTION

### 1. Field of the Invention

Exemplary embodiments relate to a steering system, and more particularly, to a fail-safe control apparatus and a control method for an electric power steering system and a steering system.

### 2. Description of the Prior Art

Generally, an electric power steering system (EPS) is installed in a vehicle in order to reduce the steering force of a steering wheel to guarantee the stability of a steering state. The EPS allows a driver to easily steer the vehicle by using the rotational force of a motor.

That is, the steering control is a control operation that generates an auxiliary steering force for assisting the steering force of the driver. To this end, stability, reliability, and so on must be guaranteed.

Therefore, since motor control is essential to realize the steering control, the EPS is equipped with a motor position sensor and a torque sensor. The position and angular velocity of the motor may be detected through the motor position sensor and the torque sensor, and the position, speed, torque, and the like of the motor may be controlled based on the detected sensing values.

At this time, when the reliability of a motor rotation angle signal is not guaranteed due to a failure of the motor position sensor, the steering control may be performed erroneously or not at all.

This may create a sense of incongruity in driving and give a sense of heterogeneity in a driver's operating a steering wheel.

### SUMMARY OF THE INVENTION

Exemplary embodiments are directed to providing a fail-safe control apparatus and a control method for an electric power steering system that controls an assistive electric current of a motor by determining whether the error is determined to be a failure or to be within a normal range when the error has occurred in a motor position sensor.

Also, exemplary embodiments are directed to providing an apparatus and method for controlling an auxiliary steering force by changing an assistive electric-current of a motor depending on a degree of error of a motor position sensor.

Also, exemplary embodiments are directed to providing a steering system configured to control an assistive electric current of a motor by determining whether an error is a failure or within a normal range when the error has occurred in a motor position sensor.

According to an aspect, there is provided a fail-safe control apparatus of an electric power steering system, the fail-safe control apparatus including a first sensing unit configured to sense motor position information, which is rotor position information of a motor that supplies an auxiliary steering force for a vehicle, and motor direction information, which is rotation direction information of the motor, a second sensing unit configured to sense steering torque information or steering angle information of the vehicle, a failure determination unit configured to compute a difference for the motor position information, estimate a direction value of the motor direction information, and perform computation between the motor position information and the steering torque information or the steering angle information to determine whether a failure has occurred, and a steering control unit configured to reduce or block an electric current output of the motor according to a result of the determination.

The fail-safe control apparatus may further include a storage unit configured to store the motor position information in real time, match the steering torque information or the steering angle information to correspond to the motor position information, and store the matched information.

According to another aspect, there is provided a fail-safe control method for an electric power steering system, the fail-safe control method including a first sensing step for sensing motor position information, which is rotor position information of a motor that supplies an auxiliary steering force for a vehicle, and motor direction information, which is rotation direction information of the motor; a second sensing step for sensing steering torque information or steering angle information of the vehicle; a failure determination step for computing a difference for the motor position information, estimating a direction value of the motor direction information, and performing computation between the motor position information and the steering torque information or the steering angle information to determine whether a failure has occurred; and a steering control step for reducing or blocking an electric current output of the motor according to a result of the determination.

The fail-safe control method may further include a storage step for storing the motor position information in real time, matching the steering torque information or the steering angle information to correspond to the motor position information, and storing the matched information.

According to another aspect, there is provided a steering system including a fail-safe control apparatus configured to control operation of a motor, wherein the fail-safe control apparatus determines an error of at least one motor position sensor and controls operation of the motor on the basis of steering angle information according to a result of the determination.

Other specific details of the exemplary embodiments are included in the detailed description and drawings.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a block diagram showing a fail-safe control apparatus of an electric power steering system (EPS) according to an exemplary embodiment;

FIG. 2 is a block diagram showing a portion of the EPS including the fail-safe control apparatus according to an exemplary embodiment;

FIG. 3 is a graph simply showing an example operation of the fail-safe control apparatus of the EPS according to an exemplary embodiment;

FIG. 4 is a flowchart of a fail-safe control method for the EPS according to an exemplary embodiment;

FIG. 5 is a detailed flowchart of a fail-safe control method for the EPS according to an exemplary embodiment;

FIGS. 6 and 7 are conceptual views illustrating fail-safe control methods according to exemplary embodiments; and

FIG. 8 is a block diagram showing the fail-safe control apparatus of the EPS, the EPS, and a computer system of the EPS according to exemplary embodiments.

### DETAILED DESCRIPTION OF THE EXEMPLARY EMBODIMENTS

Hereinafter, exemplary embodiments of the present invention will be described in detail with reference to the accompanying drawings. Advantages and features of the exemplary embodiments, and implementation methods thereof will be clarified through the following embodiments described with reference to the accompanying drawings. The exemplary embodiments may, however, be embodied in different forms and should not be construed as limited to the embodiments set forth herein. Rather, these embodiments are provided so that this disclosure will be thorough and complete and fully convey the scope of the embodiments to those skilled in the art. Therefore, the scope of the embodiments is defined only by the appended claims. Like reference numerals refer to like elements throughout.

It will be understood that, although the terms first, second etc. may be used herein to describe various elements, components, and/or sections, these elements, components, and/or sections should not be limited by these terms. These terms are only used to distinguish one element, component, or section from another element, component, or section. Thus, a first element, component, or section discussed below could be termed a second element, component, or section without departing from the technical spirit of the exemplary embodiments.

The terminology used herein is for the purpose of describing particular embodiments only and is not intended to be limiting of the exemplary embodiments. As used herein, the singular forms “a,” “an,” and “the” are intended to include the plural forms as well, unless the context clearly indicates otherwise. It will be further understood that the terms “comprises” and/or “made of,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail with reference to the accompanying drawings.

Hereinafter, a fail-safe control apparatus of an electric power steering system (EPS) and a steering system according to exemplary embodiments will be described with reference to the accompanying drawings.

The fail-safe control apparatus of the EPS according to exemplary embodiments may include a first sensing unit configured to sense motor position information, which is rotor position information of a motor that supplies an auxiliary steering force for a vehicle, and motor direction information, which is rotation direction information of the motor; a second sensing unit configured to sense steering torque information or steering angle information of the vehicle; a failure determination unit configured to compute a difference for the motor position information, estimate a direction value of the motor direction information, and perform computation between the motor position information and the steering torque information or the steering angle information to determine whether a failure has occurred; and a steering control unit configured to reduce or block an electric current output of the motor.

Here, the fail-safe control apparatus may further include a storage unit configured to store the motor position information in real time, match the steering torque information or the steering angle information to correspond to the motor position information, and store the matched information.

Here, the first sensing unit may sense first motor position information and first motor direction information through a first motor position sensor and may sense second motor position information and second motor direction information through a second motor position sensor.

Here, the first sensing unit may sense an error through the first motor position sensor and the second motor position sensor.

Here, when an error is sensed by the first motor position sensor and the second motor position sensor, the failure determination unit may determine that a failure has occurred.

Here, when an error is sensed by the first motor position sensor or the second motor position sensor, the failure determination unit may compute a difference between a current value and a previous value of each of the first motor position information and the second motor position information.

Here, the failure determination unit may determine that a failure has occurred when the difference is greater than or equal to a threshold value and may estimate direction values of the first motor direction information and the second motor direction information when the difference is less than the threshold value.

Here, the failure determination unit may determine that a failure has occurred when each of the direction values has non-sequential values for a certain time and may calculate a first steering angle corresponding to the first motor position information and a second steering angle corresponding to the second motor position information when each of the direction values has sequential values for a certain time.

Here, the failure determination unit may compute a difference between at least one of the sensed steering angle information and steering torque information and the first steering angle and compute a difference between at least one of the sensed steering angle information and steering torque information and the second steering angle.

Here, the failure determination unit may determine that a failure has occurred when each of the differences is greater than or equal to a threshold angle.

Here, the steering control unit may stop the motor by blocking the electric current of the motor when the error is determined to be a failure and may reduce the electric current output of the motor when the error is determined to be being within a normal range.

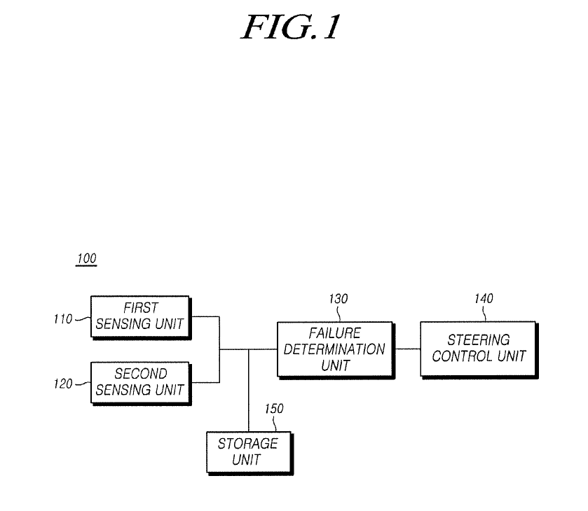

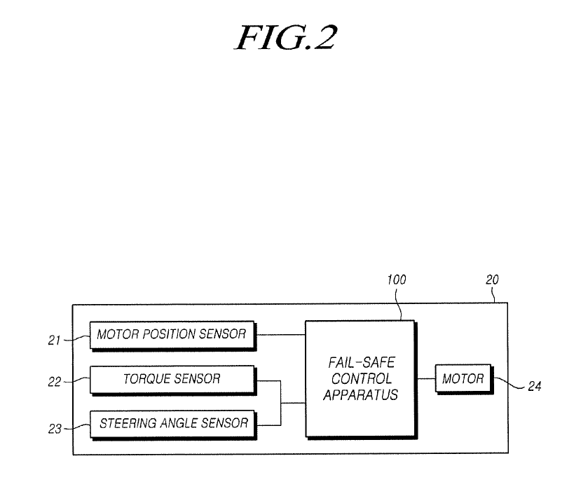

FIG. 1 is a block diagram showing a fail-safe control apparatus of an EPS 20 according to an exemplary embodiment, and FIG. 2 is a block diagram showing a portion of the EPS 20 including the fail-safe control apparatus according to an exemplary embodiment.

Referring to FIG. 1, a fail-safe control apparatus 100 of the EPS 20 according to an exemplary embodiment may include a first sensing unit 110 configured to sense motor position information, which is rotor position information of a motor 24 that supplies an auxiliary steering force for a vehicle, and motor direction information, which is rotation direction information of the motor 24, a second sensing unit 120 configured to sense steering torque information or steering angle information of the vehicle, a failure determination unit 130 configured to compute a difference for the motor position information, estimate a direction value of the motor direction information, and perform computation between the motor position information and the steering torque information or the steering angle information to determine whether a failure has occurred; and a steering control unit 140 configured to reduce or block an electric current output of the motor 24.

In this case, the fail-safe control apparatus 100 may further include a storage unit 150 configured to store the motor position information in real time, match the steering torque information or the steering angle information to correspond to the motor position information, and store the matched information.

Referring to FIG. 2, generally, the EPS 20 may include a steering wheel, a torque sensor 22 configured to sense a steering force applied to the steering wheel by a driver, a steering angle sensor 23 configured to sense a steering angle of the steering wheel, a motor 24 configured to generate an auxiliary steering force applied to the steering wheel, a motor position sensor (MPS) 21 configured to detect a rotational position of a rotor of the motor, an electronic control unit (ECU) configured to control the motor, etc.

Here, the motor 24 may generate an auxiliary steering force according to a control signal received from the fail-safe control apparatus 100 and the ECU.

In particular, the fail-safe control apparatus 100 may include the ECU, but the present invention is not limited thereto.

In detail, the ECU may compute a target steering torque value from a predetermined assistive control map on the basis of the control signal received from the torque sensor 22 and the steering angle sensor 23 and may transmit the control signal corresponding to the target steering torque value, that is, an assistive electric-current signal, to the motor 24.

Also, by determining whether the motor position sensor 21 is in a fault state on the basis of an electric signal received from the motor position sensor 21, the fail-safe control apparatus 100 may control the assistive electric-current output and transmit the assistive electric-current output to the motor 24.

In this case, the motor position sensor 21 shown in FIG. 2 is composed of a plurality of motor position sensors, which may be classified as a first motor position sensor, a second motor position sensor, and the like. However, the number of motor position sensors 21 is merely an example, but the present invention is not limited thereto.

Referring back to FIG. 1, the first sensing unit 110 may sense first motor position information and first motor direction information through the first motor position sensor and may sense second motor position information and second motor direction information through the second motor position sensor. In this case, the motor position information includes rotor position information of the motor 24, and the motor direction information includes rotation direction information of the rotor.

In addition, the first sensing unit 110 may sense an error through the first motor position sensor and the second motor position sensor.

That is, when the motor position sensor 21 cannot detect the position of the rotor of the motor 24 temporarily or when the position of the rotor changes substantially but the change in position of the rotor is erroneously detected, the first sensing unit 110 may sense occurrence of an error.

Also, the second sensing unit 120 may sense the steering torque information from the torque sensor 22 and may sense the steering angle information from the steering angle sensor 23. In this case, the steering angle of the vehicle may be estimated on the basis of the steering torque information as well as the steering angle information.

In this case, the term “sensing” used herein should be construed to mean to acquire corresponding information, and the “sensing” means to acquire information sensed by an external apparatus as well as to acquire information directly sensed by the first sensing unit 110 and the second sensing unit 120.

That is, the first sensing unit 110 and the second sensing unit 120 of the fail-safe control apparatus 100 included in the EPS 20 may sense the information through at least one of the motor position sensor 21, the torque sensor 22, and the steering angle sensor 23 through serial communication such as Serial Programming Interface (SPI) communication.

Also, when an error is sensed by the first motor position sensor and the second motor position sensor, the failure determination unit 130 may determine that a failure has occurred. That is, when an error occurs in both of the two sensors, it may be determined that the motor position sensor 21 has failed.

On the other hand, when an error is sensed by either the first motor position sensor or the second motor position sensor, the failure determination unit 130 may compute a difference between a current value and a previous value of each of the first motor position information and the second motor position information.

In other words, when an error is sensed by only the first motor position sensor or by only the second motor position sensor, the failure determination unit 130 may load the first motor position information and the second motor position information stored in the storage unit in real time. In this case, the first motor position information and the second motor position information stored at a previous time, that is, before the error is sensed by the motor position sensor 21, may correspond to the previous values, and the first motor position information and the second motor position information sensed at a current time, that is, when an error is sensed by the motor position sensor 21, may correspond to the current values.

Here, a difference between the current time and the previous time may have a certain time interval, which may be predetermined by the failure determination unit 130.

Also, the failure determination unit 130 may determine that a failure has occurred when the difference is greater than or equal to a threshold value and may estimate direction values of the first motor direction information and the second motor direction information when the difference is less than the threshold value.

As an example, the threshold value may be a positional angle of the rotor of the motor 24, and a range allowable for the threshold value may indicate 158 or higher, which is the minimum angle at which the rotor of the motor 24 is capable of being rotated by an external force.

Also, each of the estimated direction values is a value obtained by digitizing rotation direction information of the rotor. When the rotor rotates clockwise (+), each of the direction values may have values sequentially digitalized as 0, 1, 2, 3, 0, 1, 2, 3, 0, and 1. On the other hand, when the rotor rotates counterclockwise (−), each of the direction values may have values sequentially digitalized as 0, 3, 2, 1, 0, 3, 2, 1, 0, and 3.

Accordingly, the failure determination unit 130 may determine that a failure has occurred when each of the direction values has non-sequential values for a certain time and may calculate a first steering angle corresponding to the first motor position information and a second steering angle corresponding to the second motor position information when each of the direction values has sequential values for a certain time. In this case, it is assumed that the torque sensor 22 and the steering angle sensor 23 are normal.

Also, when each of the direction values has non-sequential values and the rotor rotates clockwise (+), each of the direction values may have values of 0, 1, 3, 0, 2, 3, 0, and 1 or values of 0, 1, 2, 3, 0, 0, 0, 0, and 0. That is, when it is determined that a failure has occurred, the direction value is detected as having non-sequential values because there is a missing value (the rotor being jumping) or a repeated value (the rotor being stuck).

Also, the failure determination unit 130 may compute a difference between at least one of the sensed steering angle information and steering torque information and the first steering angle and a difference between at least one of the sensed steering angle information and steering torque information and the second steering angle.

A reason why a failure of the motor position sensor 21 may be detected using the steering torque information and the steering angle information is that the motor shaft of the motor 24 is mechanically connected to the steering shaft of the steering wheel and thus there is a correlation between the rotation angle of the motor shaft and the steering angle, which is an absolute rotation angle, of the steering shaft.

In addition, the first steering angle and the second steering angle may be calculated based on the motor position information.

In this case, the failure determination unit 130 may determine that a failure has occurred when each of the differences is greater than or equal to a threshold angle. The threshold angle is greater than or equal to 27° in consideration of a correlation between the rotation angle of the motor shaft and the steering angle of the steering shaft.

Also, when the error is determined to be a failure, the steering control unit 140 may stop the motor 24 by blocking the electric current of the motor 24 when the error is determined to be a failure and may reduce the electric current output of the motor 24 when the error is determined to be within a normal range.

That is, when the assistive electric-current of the motor 24 is blocked from being output, an auxiliary steering force provided by the motor 24 becomes zero, and thus the auxiliary steering force of the vehicle is temporarily canceled.

In addition, the steering control unit 140 may visually or audibly output a failure message of the motor position sensor 21 to a cluster of the vehicle while blocking the electric current of the motor 24 from being output.

On the other hand, when the assistive electric-current of the motor 24 is decreased, a vehicle speed may also be limited and fixed by an assistive map of the ECU of the EPS 20.

As described above, there are provided a fail-safe control apparatus and a control method for an EPS that controls an assistive electric-current of a motor by the fail-safe control apparatus 100 determining whether an error is a failure or within a normal range when the error occurs in the motor position sensor.

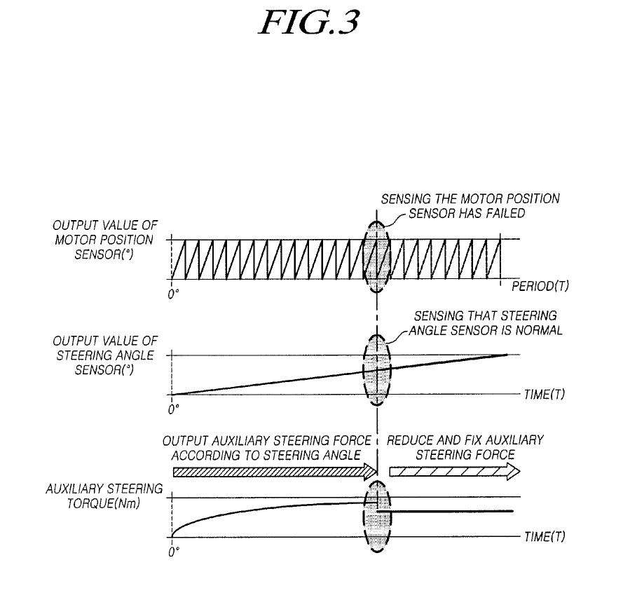

FIG. 3 is a graph simply showing an example operation of the fail-safe control apparatus of the EPS according to an exemplary embodiment.

FIG. 3 simply shows an output signal of a steering angle sensor and an output signal of one of a plurality of motor position sensors included in the EPS of the vehicle.

As shown in FIG. 3, an error is sensed by the motor position sensor, and the steering angle sensor is determined to be normal. When the error is determined to be in a normal state, an auxiliary steering force, that is, an auxiliary steering torque, which is an output signal of the motor 24, may be decreased. That is, when the auxiliary steering torque is decreased, the speed of the vehicle may also be limited and fixed.

In detail, the first sensing unit 110 may sense an error through the first motor position sensor and the second motor position sensor, and the second sensing unit 120 may sense the steering torque information through the torque sensor 22 and may sense the steering angle information through the steering angle sensor 23. In this case, it is assumed that the steering angle sensor 23 is normal.

When the error is detected, the failure determination unit 130 clearly determines whether the error is due to a failure of the motor position sensor 21. As a result, the failure determination unit 130 may block the electric current of the motor 24 through the steering control unit 140 to stop the motor 24 or may decrease the electric-current output, that is, the auxiliary steering torque, of the motor 24 as shown in FIG. 3.

Accordingly, there are provided an apparatus and method for controlling an auxiliary steering force by changing an assistive electric-current of the motor depending on a degree of error of the motor position sensor.

Referring to FIGS. 1 to 3, the steering system according to exemplary embodiments is a steering system that includes the fail-safe control apparatus 100 that controls operation of the motor 24. The steering system may determine an error of at least one motor position sensor 21 and may control operation of the motor 24 on the basis of steering angle information depending on the determination result.

Here, the steering system may further include at least one motor position sensor 21 configured to measure the state of the motor 24 to acquire motor state information; and at least one steering angle sensor 23 configured to measure a steering angle state of a steering wheel to acquire steering angle information. The fail-safe control apparatus 100 may determine an error of the motor position sensor 21 on the basis of the motor state information and the steering angle information and may control operation of the motor 24 on the basis of the steering angle information when it is determined that the motor position sensor 21 has failed.

Here, the at least one motor position sensor 21 may include a first motor position sensor configured to measure the state of the motor 24 to acquire first motor state information. The fail-safe control apparatus 100 may determine an error of the first motor position sensor on the basis of the first motor state information and the steering angle information. When it is determined that the first motor position sensor 21 has failed, the fail-safe control apparatus 100 may calculate a reduced assistive electric-current value on the basis of the steering angle information and may control operation of the motor 24 on the basis of the calculated electric-current value.

Here, the at least one motor position sensor 21 may include a first motor position sensor 21 configured to measure the state of the motor 24 to acquire first motor state information and a second motor position sensor configured to acquire second motor state information. The fail-safe control apparatus 100 may determine an error of the first motor position sensor and the second motor position sensor on the basis of the first motor state information and the second motor state information. When it is determined that either the first motor position sensor or the second motor position sensor has failed, the fail-safe control apparatus 100 may control operation of the motor 24 on the basis of the steering angle information.

Here, when it is determined that the first motor position sensor has failed and a difference between a current value and a previous value of the second motor state information is greater than or equal to a predetermined first angle value, the fail-safe control apparatus 100 may control operation of the motor 24 to achieve Loss of Assist (LOA).

Here, when the difference between the current value and the previous value of the second motor state information is less than a predetermined angle value, the fail-safe control apparatus 100 may determine rolling data for identifying a motor direction. When it is determined that the rolling data indicates a stuck state and a jumping state, the fail-safe control apparatus 100 may control operation of the motor 24 to achieve LOA.

Here, when it is determined that the rolling data does not indicate the stuck state and the jumping state, the fail-safe control apparatus 100 may compare the second motor state information to the steering angle information. When a result of the comparison is less than a predetermined second angle value, the fail-safe control apparatus 100 may calculate a reduced assistive electric-current value on the basis of the steering angle information and may control operation of the motor 24 on the basis of the calculated electric current value.

Here, the fail-safe control apparatus 100 may calculate the reduced assistive electric-current value on the basis of the steering angle information such that predetermined control is performed to fix the vehicle speed and may control operation of the motor 24 for a predetermined time on the basis of the reduced assistive electric-current value.

Here, the reduced assistive electric-current value may be smaller than an assistive electric-current value corresponding to when the motor position sensor 21 is normal.

Here, the fail-safe control apparatus 100 may further include a motor 24 having at least one of a single-winding type and a dual-winding type.

Here, the fail-safe control apparatus 100 may further include at least one torque sensor 22 configured to measure the steering torque state of the steering wheel to acquire the steering torque information and may control operation of the motor 24 on the basis of the steering torque information.

Here, a steering apparatus located between a steering wheel and a wheel to connect the steering wheel and the wheel and change the steering angle of the wheel on the basis of a rotational force applied to the steering wheel may be further included. The motor 24 may be located at one side of the steering apparatus to provide an auxiliary steering force to the steering apparatus.

In detail, the steering system according to exemplary embodiments may include the fail-safe control apparatus 100 and the like.

That is, the steering system according to exemplary embodiments may include the fail-safe control apparatus 100 that controls operation of the motor 24.

The fail-safe control apparatus 100 may determine an error of the at least one motor position sensor 21 and may control operation of the motor 24 according to a result of the determination.

As an example, the fail-safe control apparatus 100 may determine an error of the at least one motor position sensor 21. When it is determined that the motor position sensor 21 has failed, the fail-safe control apparatus 100 may control operation of the motor 24 on the basis of the steering angle information.

That is, the fail-safe control apparatus 100 may determine an error of the at least one motor position sensor 21. When it is determined that the motor position sensor 21 has failed, the fail-safe control apparatus 100 may calculate a reduced assistive electric-current value on the basis of the steering angle information and may control operation of the motor 24 on the basis of the calculated electric-current value.

As another example, the fail-safe control apparatus 100 may determine an error of the at least one motor position sensor 21. When it is determined that the motor position sensor 21 is normal, the fail-safe control apparatus 100 may control operation of the motor 24 on the basis of the steering torque information.

That is, the fail-safe control apparatus 100 may determine an error of the at least one motor position sensor 21. When it is determined that the motor position sensor 21 has failed, the fail-safe control apparatus 100 may calculate a reduced assistive electric-current value on the basis of the steering angle information and may control operation of the motor 24 on the basis of the calculated electric-current value.

Here, the reduced assistive electric-current value may be smaller than the assistive electric-current value.

The steering system according to exemplary embodiments may include at least one of at least one motor position sensor 21, at least one steering angle sensor 23, and at least one torque sensor 22.

The steering system may include at least one motor position sensor 21. The motor position sensor 21 may measure the state of the motor 24 to acquire motor state information.

Here, the motor state information may include at least one of motor position information and motor direction information, but the present invention is not limited thereto. The motor state information may contain any information as long as the information can indicate the state of the motor.

The steering system may include at least one steering angle sensor 23. The steering angle sensor 23 may measure a steering angle state of the steering wheel to acquire the steering angle information.

The steering system may include at least one torque sensor 22. The torque sensor 22 may measure a steering torque state of the steering wheel to acquire the steering torque information.

The steering angle sensor 23 and the torque sensor 22 may be separately provided, but are not limited thereto. The steering angle sensor 23 and the torque sensor 22 may be provided as a single component through a torque and angle sensor (TAS).

The fail-safe control apparatus 100 may determine an error of the motor position sensor 21 on the basis of the motor state information and the steering angle information and may control operation of the motor 24 according to a result of the determination.

As an example, the fail-safe control apparatus 100 may determine an error of the motor position sensor 21 on the basis of the motor state information and the steering angle information. When it is determined that the motor position sensor 21 has failed, the fail-safe control apparatus 100 may control operation of the motor 24 on the basis of the steering angle information.

That is, the fail-safe control apparatus 100 may determine an error of the motor position sensor 21 on the basis of the motor state information and the steering angle information. When it is determined that the motor position sensor 21 has failed, the fail-safe control apparatus 100 may calculate a reduced assistive electric-current value on the basis of the steering angle information and may control operation of the motor 24 on the basis of the calculated electric-current value.

As another example, the fail-safe control apparatus 100 may determine an error of the motor position sensor 21 on the basis of the motor state information and the steering angle information. When it is determined that the motor position sensor 21 is normal, the fail-safe control apparatus 100 may control operation of the motor 24 on the basis of the steering torque information.

That is, the fail-safe control apparatus 100 may determine an error of the motor position sensor 21 on the basis of the motor state information and the steering angle information. When it is determined that the motor is normal, the fail-safe control apparatus 100 may calculate an assistive electric-current value on the basis of the steering angle information and may control operation of the motor 24 on the basis of the calculated electric-current value.

In particular, the at least one motor position sensor 21 may include a first motor position sensor configured to measure the state of the motor to acquire first motor state information.

Here, the fail-safe control apparatus 100 may acquire the position and direction of the motor on the basis of the first motor state information.

In this case, the fail-safe control apparatus 100 may determine an error of the first motor position sensor on the basis of the first motor state information and the steering angle information and may control operation of the motor 24 according to a result of the determination.

As an example, the fail-safe control apparatus 100 may determine an error of the first motor position sensor 21 on the basis of the first motor state information and the steering angle information. When it is determined that the first motor position sensor 21 has failed, the fail-safe control apparatus 100 may control operation of the motor 24 on the basis of the steering angle information.

That is, the fail-safe control apparatus 100 may determine an error of the first motor position sensor 21 on the basis of the first motor state information and the steering angle information. When it is determined that the first motor position sensor 21 has failed, the fail-safe control apparatus 100 may calculate a reduced assistive electric-current value on the basis of the steering angle information and may control operation of the motor 24 on the basis of the calculated electric-current value.

As another example, the fail-safe control apparatus 100 may determine an error of the first motor position sensor 21 on the basis of the first motor state information and the steering angle information. When it is determined that the first motor position sensor 21 is normal, the fail-safe control apparatus 100 may control operation of the motor 24 on the basis of the steering torque information.

That is, the fail-safe control apparatus 100 may determine an error of the first motor position sensor 21 on the basis of the first motor state information and the steering angle information. When it is determined that the first motor position sensor 21 is normal, the fail-safe control apparatus 100 may calculate an assistive electric-current value on the basis of the steering torque information and may control operation of the motor 24 on the basis of the calculated electric-current value.

Also, the at least one motor position sensor 21 may include a first motor position sensor configured to measure the state of the motor 24 to acquire first motor state information and a second motor position sensor configured to acquire second motor state information.

Here, the fail-safe control apparatus 100 may acquire the position and direction of the motor 24 on the basis of the first motor state information and the second motor state information.

In this case, the fail-safe control apparatus 100 may determine an error of the first motor position sensor and the second motor position sensor on the basis of the first motor state information and the second motor state information and may control operation of the motor 24 according to a result of the determination.

As an example, the fail-safe control apparatus 100 may determine an error of the first motor position sensor and the second motor position sensor on the basis of the first motor state information and the second motor state information. When it is determined that both of the first motor position sensor and the second motor position sensor are normal, the fail-safe control apparatus 100 may control operation of the motor 24 on the basis of the steering torque information.

That is, the fail-safe control apparatus 100 may determine an error of the first motor position sensor and the second motor position sensor on the basis of the first motor state information and the second motor state information. When it is determined that both of the first motor position sensor and the second motor position sensor are normal, the fail-safe control apparatus 100 may calculate an assistive electric-current value on the basis of the steering torque information and may control operation of the motor 24 on the basis of the calculated electric-current value.

As another example, the fail-safe control apparatus 100 may determine an error of the first motor position sensor and the second motor position sensor on the basis of the first motor state information and the second motor state information. When it is determined that both of the first motor position sensor and the second motor position sensor have failed, the fail-safe control apparatus 100 may control operation of the motor 24 to achieve LOA.

That is, the fail-safe control apparatus 100 may determine an error of the first motor position sensor and the second motor position sensor on the basis of the first motor state information and the second motor state information. When it is determined that both of the first motor position sensor and the second motor position sensor have failed, the fail-safe control apparatus 100 may calculate an electric-current value corresponding to LOA and may control operation of the motor 24 on the basis of the calculated electric-current value.

Here, the electric-current value corresponding to LQA may be zero. Thus, when it is determined that both of the first motor position sensor and the second motor position sensor have failed, the fail-safe control apparatus 100 may determine an electric current value provided to the motor 24 as zero and may manually operate the steering of the vehicle to block the output of the motor 24, that is, to achieve LOA.

As another example, the fail-safe control apparatus 100 may determine an error of the first motor position sensor and the second motor position sensor on the basis of the first motor state information and the second motor state information. When it is determined that either the first motor position sensor or the second motor position sensor is normal, the fail-safe control apparatus 100 may control operation of the motor 24 on the basis of the steering angle information.

That is, the fail-safe control apparatus 100 may determine an error of the first motor position sensor and the second motor position sensor on the basis of the first motor state information and the second motor state information. When it is determined that either the first motor position sensor or the second motor position sensor has failed, the fail-safe control apparatus 100 may calculate a reduced assistive electric-current value on the basis of the steering angle information and may control operation of the motor 24 on the basis of the calculated electric-current value.

In detail, when it is determined that the first motor position sensor has failed as a result of the determination of the error of the first motor position sensor and the second motor position sensor and a difference between a current value and a previous value of the second motor state information is greater than or equal to a predetermined first angle value, the fail-safe control apparatus 100 may control operation of the motor 24 to achieve LOA.

Also, when the difference between the current value and the previous value of the second motor state information is less than a predetermined angle value, the fail-safe control apparatus 100 may determine rolling data for identifying a motor direction. When it is determined that the rolling data indicates a stuck state and a jumping state, the fail-safe control apparatus 100 may control operation of the motor 24 to achieve LOA.

Also, when it is determined that the rolling data for identifying the motor direction does not indicate the stuck state and the jumping state as a result of the determination of the rolling data, the fail-safe control apparatus 100 may compare the second motor state information to the steering angle information. When a result of the comparison is less than a predetermined second angle value, the fail-safe control apparatus 100 may calculate a reduced assistive electric-current value on the basis of the steering angle information and may control operation of the motor 24 on the basis of the calculated electric current value.

Also, when it is determined that the rolling data for identifying the motor direction does not indicate the stuck state and the jumping state as a result of the determination of the rolling data, the fail-safe control apparatus 100 may compare the second motor state information to the steering angle information. When a result of the comparison is greater than or equal to a predetermined second angle value, the fail-safe control apparatus 100 may control operation of the motor 24 to achieve LOA.

That is, when it is determined that the rolling data for identifying the motor direction does not indicate the stuck state and the jumping state as a result of the determination of the rolling data, the fail-safe control apparatus 100 may compare the second motor state information to the steering angle information. When a result of the comparison, that is, a difference between the second motor state information and the steering angle information, is greater than or equal to a predetermined second angle value, the fail-safe control apparatus 100 may control operation of the motor 24 to achieve LOA.

Here, the predetermined first angle value and the predetermined second angle may be a single value, but are not limited thereto. The predetermined first angle value and the predetermined second angle may be composed of two or more values and/or ranges. Also, the predetermined first angle value and the predetermined second angle value may have different values, but are not limited thereto. The predetermined first angle value and the predetermined second angle value may have the same value.

The fail-safe control apparatus 100 may calculate a reduced assistive electric-current value on the basis of the steering angle information such that predetermined control is performed to fix the vehicle speed and may control operation of the motor 24 for a predetermined time on the basis of the reduced assistive electric-current value.

Here, the reduced assistive electric-current value may be smaller than an assistive electric-current value corresponding to when the motor position sensor 21 is normal.

The steering system according to exemplary embodiments may include a motor 24.

The operation of the motor 24 may be controlled on the basis of the assistive electric-current.

The motor 24 may include at least one of a single-winding type motor and a dual-winding type motor, but the present invention is not limited thereto. The motor 24 may include any motor as long as the motor can assist in steering a vehicle.

The motor 24 may include a third-phase motor, but the present invention is not limited thereto. The motor 24 may include any motor as long as the motor 24 can assist in steering a vehicle (e.g., at least one of a first-phase motor, a second-phase motor, and a fourth-phase-or-more motor).

The motor 24 may include at least one of a direct current (DC) motor and an alternating current (AC) motor, but the present invention is not limited thereto. The motor 24 may include any motor as long as the motor 24 can assist in steering a vehicle (e.g., at least one of an induction motor and a permanent-magnet synchronous motor).

The steering system according to exemplary embodiments may include a steering apparatus.

The steering apparatus may be located between the steering wheel and a wheel and configured to connect the steering wheel and the wheel and change the steering angle of the wheel on the basis of a rotational force applied to the steering wheel. In particular, the motor 24 may be located at one side of the steering apparatus and configured to provide an auxiliary steering force to the steering apparatus.

The steering apparatus may largely include a steering manipulation unit, a steering gear unit, and a steering link unit. The steering apparatus may refer to a mechanical part of the steering system.

The steering manipulation unit may transfer a rotational force to the steering gear unit due to a driver manipulating the steering wheel. The steering manipulation unit may include at least one of a steering wheel, a steering shaft, and a steering column middle shaft, but the present invention is not limited thereto. The steering manipulation unit may include any mechanism (or apparatus) as long as the mechanism can transfer a rotational force to the steering gear unit.

The steering gear unit may receive a rotational force from the steering manipulation unit and then decrease the rotation and increase the torque to change a direction of motion to linear motion. The steering gear unit may include at least one of a worm sector type, a ball nut type, a variable gear ratio type, and a rack pinion type, but the present invention is not limited thereto. The steering gear unit may include any mechanism (or apparatus) as long as the mechanism can change a direction of motion to linear motion.

The steering link unit may transfer movement of the steering gear to the front wheels to change the angle of the wheels. The steering link unit may include at least one of a rack, a tie rod, and a knuckle arm, but the present invention is not limited thereto. The steering link unit may include any mechanism (or apparatus) as long as the mechanism can change the angle of a wheel.

The steering system according to exemplary embodiments may include at least one of a hydraulic power steering (HPS), an electro-hydraulic power steering (EHPS), and an EPS, but the present invention is not limited thereto. The steering system may include any steering scheme.

The steering system according to exemplary embodiment may be duplicated.

That is, the components included in the steering system according to exemplary embodiments, that is, the motor position sensor 21, the torque sensor 22, the steering angle sensor 23, the fail-safe control apparatus 100, and the motor 24, may be duplicated. Here, the duplication means that two or more components perform the same function.

For example, the steering system according to exemplary embodiments may include a first fail-safe control apparatus and a second fail-safe control apparatus. Also, the steering system according to exemplary embodiments may include at least one first motor position sensor, at least one second motor position sensor, at least one first torque sensor, at least one second torque sensor, at least one first steering angle sensor, at least one second steering angle sensor, etc.

When the motor is a single-winding type motor, the first fail-safe control apparatus may control 100% of the output of the motor. In this case, when the at least one first motor position sensor has failed, the first fail-safe control apparatus may control operation of the motor on the basis of the steering angle information (e.g., reduced assistive control) or may transfer the control right to the second fail-safe control apparatus instead of controlling the operation of the motor. Also, the second fail-safe control apparatus having the control right may control the motor. Subsequently, when at least one second motor position sensor has failed, the second fail-safe control apparatus may control the operation of the motor on the basis of the steering angle information (e.g., the reduced assistive control) or may not control the operation of the motor.

Also, when the motor is a dual-winding type motor, the first fail-safe control apparatus and the second fail-safe control apparatus may control the output of the motor at a ratio of 50:50 through a first winding and a second winding of the motor. Also, when the at least one first motor position sensor has failed, the first fail-safe control apparatus may control operation of the motor on the basis of the steering angle information (e.g., reduced assistive control) or may not control the operation of the motor. In this case, the second fail-safe control apparatus may control 50% of the output of the motor normally, that is, on the basis of the steering torque information. Also, when the at least one first motor position sensor and the at least one second motor position sensor have failed, at least one of the first fail-safe control apparatus and the second fail-safe control apparatus may control operation of the motor on the basis of the steering angle information (e.g., the reduced assistive control) or may not control the operation of the motor.

A fail-safe control method for the EPS according to exemplary embodiments will be described below with reference to the accompanying drawings.

The fail-safe control method for the EPS according to exemplary embodiments may include a first sensing step for sensing motor position information, which is rotor position information of a motor that supplies an auxiliary steering force for a vehicle, and motor direction information, which is rotation direction information of the motor; a second sensing step for sensing steering torque information or steering angle information of the vehicle; a failure determination step for computing a difference for the motor position information, estimating a direction value of the motor direction information, and performing computation between the motor position information and the steering torque information or the steering angle information to determine whether a failure has occurred; and a steering control step for reducing or blocking an electric current output of the motor.

Here, the fail-safe control method may further include a storage step for storing the motor position information in real time, matching the steering torque information or the steering angle information to correspond to the motor position information, and storing the matched information.

Here, the first sensing step may include sensing first motor position information and first motor direction information through a first motor position sensor and sensing second motor position information and second motor direction information through a second motor position sensor.

Here, the first sensing step may include sensing an error through the first motor position sensor and the second motor position sensor.

Here, the steering control step may include stopping the motor by blocking the electric current of the motor when the error is determined to be a failure and reducing the electric current output of the motor when the detected error is determined to be normal.

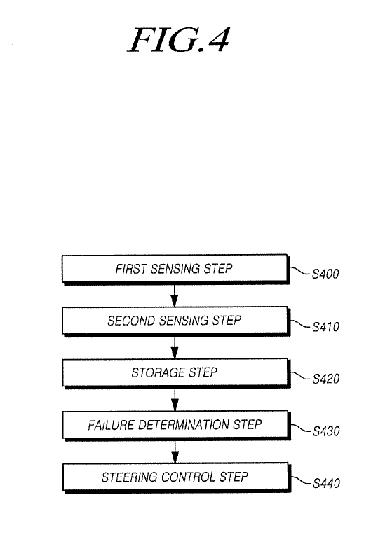

FIG. 4 is a flowchart of a fail-safe control method for the EPS according to an exemplary embodiment.

Referring to FIG. 4, the fail-safe control method for the EPS according to an exemplary embodiment may include a first sensing step for sensing motor position information, which is rotor position information of a motor that supplies an auxiliary steering force for a vehicle, and motor direction information, which is rotation direction information of the motor (S400), a second sensing step for sensing steering torque information or steering angle information of the vehicle (S410), a failure determination step for computing a difference for the motor position information, estimating a direction value of the motor direction information, and performing computation between the motor position information and the steering torque information or the steering angle information to determine whether a failure has occurred (S430), and a steering control step for reducing or blocking an electric current output of the motor (S440).

In detail, the first sensing step S400 may include sensing first motor position information and first motor direction information through the first motor position sensor and sensing second motor position information and second motor direction information through the second motor position sensor.

In addition, the first sensing step S400 may include sensing an error through the first motor position sensor and the second motor position sensor.

Also, the second sensing step S410 may include sensing the steering torque information through a torque sensor and sensing the steering angle information through a steering angle sensor. In this case, the steering angle of the vehicle may be estimated on the basis of the steering torque information as well as the steering angle information.

In this case, the fail-safe control method for the EPS according to an exemplary embodiment may further include a storage step S420 for storing the motor position information in real time, matching the steering torque information or the steering angle information to correspond to the motor position information, and storing the matched information.

Also, the failure determination step S430 may include determining when an error is determined to be a failure or to be normal when the error is sensed through the first motor position sensor and the second motor position sensor. In this case, the determination may be made by computing a difference between a current value and a previous value of each of the first motor position information and the second motor position information, estimating direction values of the first motor direction information and the second motor direction information, or calculating a difference for the steering angle.

Here, the steering control step S440 may include stopping the motor by blocking the electric current of the motor when the error is determined to be a failure and reducing the electric current output of the motor when the error is determined to be within a normal range.

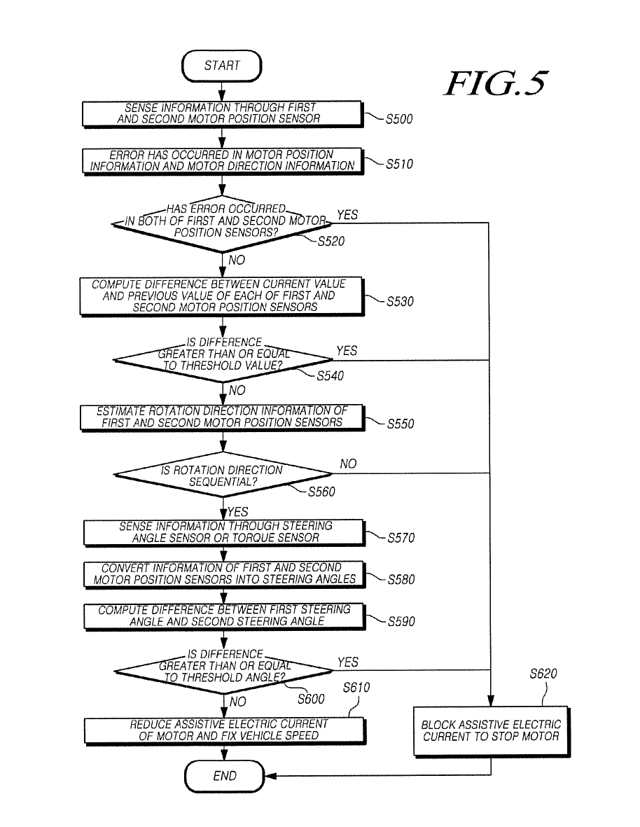

FIG. 5 is a detailed flowchart of a fail-safe control method for the EPS according to an exemplary embodiment.

Referring to FIG. 5, the fail-safe control method includes sensing the motor position information and the motor direction information through the first motor position sensor and the second motor position sensor in the first sensing step S400 (S500).

In this case, when a problem occurs in the first motor position sensor or the second motor position sensor, an error occurs in the sensed motor position information and motor direction information (S510).

Then, the fail-safe control method includes determining whether an error has occurred in both of the first motor position sensor and the second motor position sensor in the failure determination step S430 (S520).

In this case, the fail-safe control method includes temporarily canceling the auxiliary steering force of the vehicle by blocking an assistive electric-current applied to the motor to stop the motor in the steering control step S440 when an error has occurred in both of the first motor position sensor and the second motor position sensor (S620).

On the other hand, the fail-safe control method includes computing a difference between a current value and a previous value of the first motor position information and the second motor position information when an error has occurred in either the first motor position sensor or the second motor position sensor (S530). That is, the fail-safe control method includes calculating the difference between the current value and the previous value of the first motor position sensor and the difference between the current value and the previous value in the failure determination step 430 using real-time sensing information of the first motor position sensor and the second motor position sensor stored in the storage step S420.

Then, the fail-safe control method includes whether the differences of the first motor position sensor and the second motor position sensor are greater than or equal to a threshold value (S540).

In this case, the fail-safe control method includes temporarily canceling the auxiliary steering angle of the vehicle by determining that a failure has occurred and blocking the assistive electric-current applied to the motor to stop the motor when the differences are greater than or equal to the threshold value (S620).

On the other hand, the fail-safe control method includes estimating rotation direction information, that is, direction values of the first motor position sensor and the second motor position sensor when the differences are less than the threshold value (S550).

Also, the fail-safe control method includes determining whether the rotation direction information has sequential values for a predetermined certain time (S560).

In this case, the fail-safe control method includes determining that a failure has occurred when the rotation direction information is not sequential and temporarily canceling the auxiliary steering force of the vehicle by blocking the assistive electric current applied to the motor to stop the motor (S620).

On the other hand, the fail-safe control method includes sensing the steering angle information or the steering torque information through the steering angle sensor or the torque sensor in the second sensing step S410 when the rotation direction information is sequential (S570).

Also, the fail-safe control method includes converting the information sensed by the first motor position sensor and the second motor position sensor into a first steering angle and a second steering angle (S580).

In this case, the first steering angle is a steering angle corresponding to the first motor position information, and the second steering angle is a steering angle corresponding to the second motor position information.

Also, the fail-safe control method includes computing a difference between a steering angle sensed through the steering angle sensor or the torque sensor and the first steering angle and a difference between the sensed steering angle and the second steering angle (8590).

Also, the fail-safe control method includes determining whether the differences are greater than or equal to a threshold angle (S600).

In this case, the fail-safe control method includes temporarily canceling the auxiliary steering angle of the vehicle by determining that a failure has occurred and blocking the assistive electric-current applied to the motor to stop the motor when the differences are greater than or equal to the threshold value (S620).

On the other hand, the fail-safe control method includes reducing the assistive electric current of the motor, reducing the auxiliary steering force, and limiting and fixing the speed of the vehicle when the differences are less than the threshold angle.

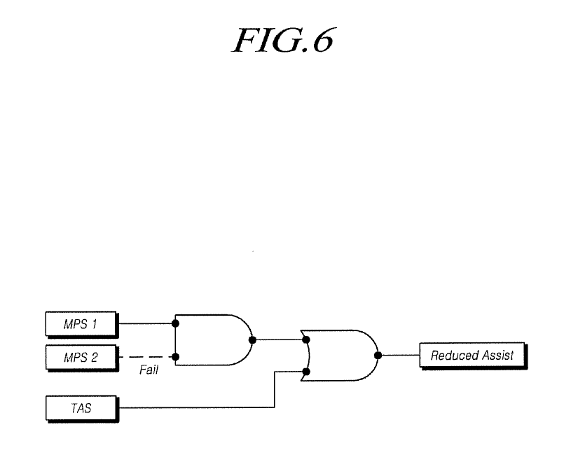

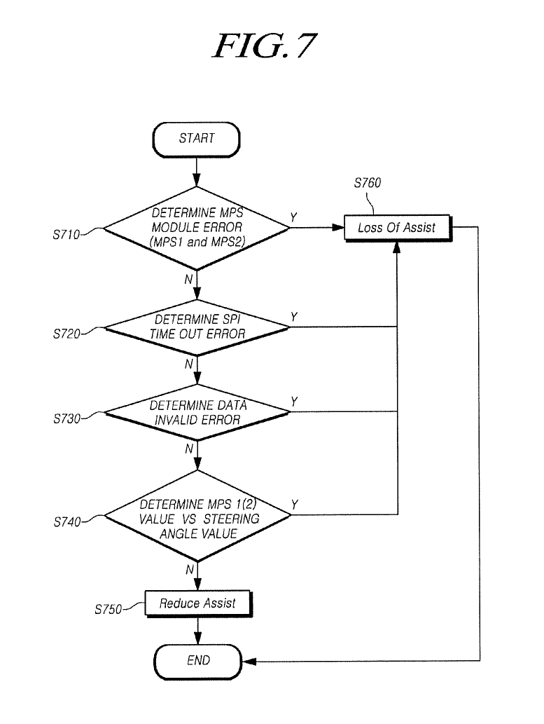

FIGS. 6 and 7 are conceptual views illustrating fail-safe control methods according to exemplary embodiments.

Referring to FIG. 6, according to the fail-safe control apparatus and the control method for the EPS, and the steering system according to exemplary embodiments, by performing reduced assistive control using steering angle information (or signal) provided by a TAS when the second motor position sensor (MPS 2) has failed, it is possible to improve driving stability and also reduce steering disturbance.

Referring to FIG. 7, first, an error of a motor position sensor (MPS) module may be determined.

That is, when an error has occurred in the MPS module, the operation of the motor may be controlled to achieve LOA (S760).

On the other hand, when no error occurs in the MPS module, an SPI time-out error may be determined (S720).

In S720, when a difference between a current value and an old value of raw data delivered through SPI is greater than or equal to a predetermined value (e.g., 15 deg), an error may occur. For example, when MPS 1(2) Law Value Diff is greater than or equal to 15 deg (“current raw data”−“old raw data+AB”), an error may occur. Since the motor is rotated by a person, it is not physically possible to generate 15 deg or higher.

That is, when an SPI time out error has occurred, the operation of the motor may be controlled to achieve LOA (S760).

Also, when no SPI Time Out Error occurs, a data invalid error may be determined (S730).

In S730, “stuck” and “jumping” of the rolling data AB for identifying a lateral direction may be checked, and the data invalid error may be determined on the basis of a result of the check.

Here, AB means the rolling data for identifying the motor direction.

In particular, CW direction may be 0→□1→□2□→3□→0→1□→2□→3, and CCW direction may be 0□→3□→2□→1□→0→3□→2→□1.

That is, when a data invalid error has occurred, the operation of the motor may be controlled to achieve LOA (S760).

On the other hand, when no data invalid error has occurred, an MPS 1(2) value and a steering angle value may be determined (S740).

When only the MPS sensor has failed in S740, steering angle sensor values are compared. When a result of the comparison is greater than or equal to a predetermined value (e.g., 27 deg), it may be determined that an error has occurred.

Here, the criterion for the determination of 27 deg may be derived with reference to a Sent Diff value for angle calculation.

That is, when a difference between the MPS 1(2) value and the steering angle value is greater than or equal to the predetermined value, the operation of the motor may be controlled to achieve LOA (S760).

On the other hand, when a difference between the MPS 1(2) value and the steering angle value is less than the predetermined value, the operation of the motor may be controlled to achieve LOA (S750).

Here, the reduced assistive may be 100 Kph vehicle speed fixing control (electric current control).

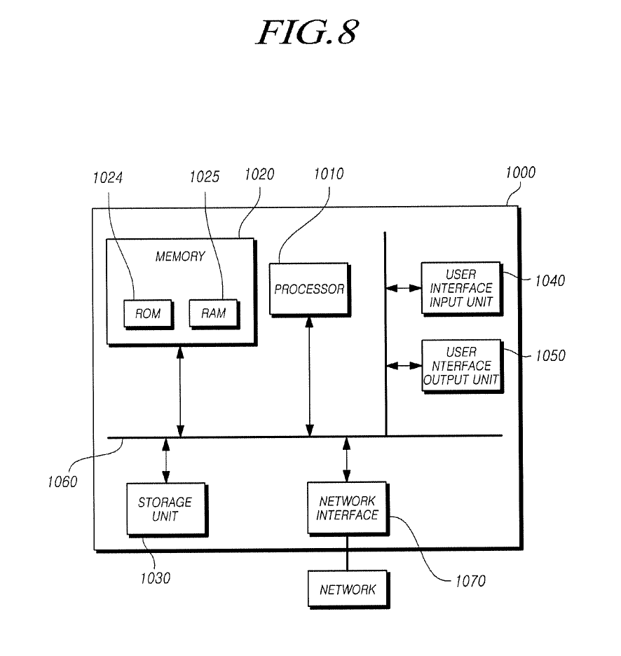

FIG. 8 is a block diagram showing the fail-safe control apparatus of the EPS, the EPS, and a computer system of the EPS according to exemplary embodiments.

Referring to FIG. 8, the above-described exemplary embodiments may be implemented in a computer system, for example, as a computer readable recording medium. As shown in FIG. 8, the computer system 1000 of the fail-safe control apparatus of the EPS, the EPS, the steering system, and the like may include at least one of one or more processors 1010, a memory 1020, a storage unit 1030, a user interface input unit 1040, and a user interface output unit 1050, which may communicate with each other through a bus 1060. Also, the computer system 1000 may include a network interface 1070 for connecting to a network. A processor 1010 may be a central processing unit (CPU) or a semiconductor device for executing processing instructions stored in the memory 1020 and/or the storage 1030. The memory 1020 and the storage unit 1030 may include various types of volatile/non-volatile memory media. For example, the memory may include a read-only memory (RCOM) 1021 and a random access memory (RAM) 1023.

Thus, the exemplary embodiments may be implemented as a computer or a non-volatile recording medium in which computer executable instructions are stored. When executed by a processor, the instructions may perform the method according to the exemplary embodiments.

As described above, according to the fail-safe control apparatus and the control method for the EPS according to exemplary embodiments, by decreasing the auxiliary steering force of the vehicle according to a degree of error when an error has occurred in the motor position sensor, it is possible to reduce a sense of heterogeneity in steering operation.

Also, the failure of the motor position sensor is determined according to a specified condition, and thus it is possible to enhance driving stability.

Also, the fail-safe control apparatus and the control method for the EPS, and the steering system according to exemplary embodiments may temporarily cancel an auxiliary steering force by notifying a driver that the motor position sensor has failed and by stopping the motor according to a degree of error when an error is detected in a motor position sensor and may also change the assistive electric-current of the motor according to a degree of error of the motor position sensor. Thus, it is possible to reduce steering disturbance as well as to improve driving stability.

According to the above-described exemplary embodiments, when an error has occurred in a motor position sensor, an auxiliary steering force of a vehicle is decreased according to a degree of error, and thus it is possible to reduce a sense of heterogeneity in steering operation.

Also, the failure of the motor position sensor is determined according to a specified condition, and thus it is possible to enhance driving stability.

Even though all of the components of the exemplary embodiments have been described as being combined into a single component or as operating in combination, the exemplary embodiments are not necessarily limited thereto. In other words, within the scope of the embodiments, all the components may selectively combine into one or more components to operate in combination.

The above description is only illustrative of the technical idea of the exemplary embodiments, and those skilled in the art will appreciate that various modifications, additions and substitutions are possible, without departing from the essential characteristics of the embodiments. The scope of the exemplary embodiments should be construed by the appended claims, and all technical sprits within the scope of their equivalents should be construed as included in the scope of the embodiments.

What is claimed is:

1. A fail-safe control apparatus of an electric power steering system, the fail-safe control apparatus comprising:
a first sensing unit configured to sense motor position information, which is rotor position information of a motor that supplies an auxiliary steering force for a vehicle, and motor direction information, which is rotation direction information of the motor;
a second sensing unit configured to sense steering torque information or steering angle information of the vehicle;
a failure determination unit configured to compute a difference for the motor position information, estimate a direction value of the motor direction information, and perform computation between the motor position information and the steering torque information or the steering angle information to determine whether a failure has occurred; and
a steering control unit configured to reduce or block an electric current output of the motor according to a result of the determination.

2. The fail-safe control apparatus of claim 1, wherein when an error is detected through a first motor position sensor or a second motor position sensor, the failure determination unit computes a difference between a current value and a previous value of each of the first motor position information and the second motor position information.

3. The fail-safe control apparatus of claim 2, wherein the failure determination unit determines that a failure has occurred when the differences are greater than or equal to a threshold value and estimates direction values of the first motor direction information and the second motor direction information when the differences are less than the threshold value.

4. The fail-safe control apparatus of claim 3, wherein the failure determination unit determines that a failure has occurred when each of the direction values has non-sequential values for a certain time and calculates a first steering angle corresponding to the first motor position information and a second steering angle corresponding to the second motor position information when each of the direction values has sequential values for a certain time.

5. The fail-safe control apparatus of claim 4, wherein the failure determination unit computes a difference between at least one of the sensed steering angle information and steering torque information and the first steering angle and computes a difference between at least one of the sensed steering angle information and steering torque information and the second steering angle.

6. The fail-safe control apparatus of claim 5, wherein the failure determination unit determines that a failure has occurred when the differences are greater than or equal to a threshold angle.

7. A fail-safe control method for an electric power steering system, the fail-safe control method comprising:
a first sensing step for sensing motor position information, which is rotor position information of a motor that supplies an auxiliary steering force for a vehicle, and motor direction information, which is rotation direction information of the motor;
a second sensing step for sensing steering torque information or steering angle information of the vehicle;
a failure determination step for computing a difference for the motor position information, estimating a direction value of the motor direction information, and performing computation between the motor position information and the steering torque information or the steering angle information to determine whether a failure has occurred; and
a steering control step for reducing or blocking an electric current output of the motor according to a result of the determination.

8. The fail-safe control method of claim 7, further comprising a storage step for storing the motor position information in real time, matching the steering torque information or the steering angle information to correspond to the motor position information, and storing the matched information.

9. The fail-safe control method of claim 7, wherein the first sensing step comprises sensing first motor position information and first motor direction information through a first motor position sensor and sensing second motor position information and second motor direction information through a second motor position sensor.

10. The fail-safe control method of claim 9, wherein the first sensing step comprises sensing an error through the first motor position sensor and the second motor position sensor.

11. The fail-safe control method of claim 10, wherein the steering control step comprises blocking an electric current of the motor to stop the motor when it is determined that a failure has occurred and reducing an electric current output of the motor when it is determined that an error has occurred but is determined to be normal.

12. A steering system comprising a fail-safe control apparatus configured to control operation of a motor, wherein the fail-safe control apparatus determines an error of at least one motor position sensor and controls operation of the motor on the basis of steering angle information according to a result of the determination.

13. The steering system of claim 12, further comprising:
at least one motor position sensor configured to measure a state of the motor to acquire motor state information; and
at least one steering angle sensor configured to measure a steering angle state of a steering wheel to acquire steering angle information,
wherein the fail-safe control apparatus determines an error of the motor position sensor on the basis of the motor state information and the steering angle information and controls operation of the motor on the basis of the steering angle information when it is determined that the motor position sensor has failed.

14. The steering system of claim 13,
wherein the at least one motor position sensor comprises a first motor position sensor configured to measure the state of the motor and acquire first motor state infatuation, and
wherein the fail-safe control apparatus determines an error of the first motor position sensor on the basis of the first motor state information and the steering angle information and wherein the fail-safe control apparatus calculates a reduced assistive electric-current value on the basis of the steering angle information when it is determined that the first motor position sensor has failed and controls operation of the motor on the basis of the calculated electric-current value.

15. The steering system of claim 13,
wherein the at least one motor position sensor comprises a first motor position sensor configured to measure the state of the motor to acquire first motor state information and a second motor position sensor configured to acquire second motor state information, and
wherein the fail-safe control apparatus determines an error of the first motor position sensor and the second motor position sensor on the basis of the first motor state information and the second motor state information and controls operation of the motor on the basis of the steering angle information when it is determined that either the first motor position sensor or the second motor position sensor has failed.
